(19) United States
(12) Patent Application Publication
(10) Pub. No.: US 2024/0337128 A1
(43) Pub. Date: Oct. 10, 2024

(54) Swimming pool cleaning robot

(71) Applicant: Shenzhen Seauto Technology Co., Ltd., Shenzhen (CN)

(72) Inventor: Zhuoming Deng, Shenzhen (CN)

(21) Appl. No.: 18/743,128

(22) Filed: Jun. 14, 2024

Related U.S. Application Data
(62) Division of application No. 17/577,765, filed on Jan. 18, 2022.

(30) Foreign Application Priority Data
Dec. 7, 2021 (CN) 202111484545.0

(51) Int. Cl. E04H 4/16; G05D 1/00; G05D 1/221; G05D 1/224

(52) U.S. Cl. CPC E04H 4/1654; G05D 1/00; G05D 1/221; G05D 1/2243

(57) ABSTRACT

The present disclosure belongs to the technical field of swimming pool cleaning, in particular to a swimming pool cleaning robot and a steering method, which including a cleaning robot body, an angle sensor, a gyroscope sensor and an acceleration sensor arranged inside the cleaning robot body, as well as first sonar and second sonar fixed on the forward side of the cleaning machine body. The present disclosure solves the problem of low random cleaning efficiency of the traditional cleaning robot, and there is no need to plan the cleaning route, and can be directly used in the swimming pool. The scraping assembly can scrape the dirty at the bottom of the swimming pool, and then facilitate the suction of the sewage suction port. It has a strong cleaning effect for some dirty stuck at the bottom of the swimming pool that is difficult to suck.

### RELATED APPLICATIONS

This application is a division of U.S. application Ser. No. 17/577,765 filed on Jan. 18, 2022, which claims the benefit of priority to Chinese Patent Application Number 202111484545.0 filed on Dec. 7, 2021. The entire contents of the above-identified application are hereby incorporated by reference.

### TECHNICAL FIELD

The present disclosure relates to the technical field of swimming pool cleaning, and particularly relates to a swimming pool cleaning robot and a steering method.

### BACKGROUND

Swimming pool that provides people with swimming activities must be kept clean and hygienic. The pool water is usually changed regularly and the pool is cleaned manually. In recent years, some developed countries and regions have adopted automatic mechanical, equipment-swimming pool automatic cleaning machine, which can automatically clean the swimming pool without discharging the pool water. In this way, it not only saves valuable water resources, but also replaces the heavy labor of manually cleaning the swimming pool.

There are two working modes of the existing swimming pool cleaning robot:
1. Place the robot in the swimming pool, the robot moves in one direction randomly, and turns around after colliding with the swimming pool wall. The robot moves irregularly in the swimming pool and cannot clean the swimming pool well.
2. In order for the swimming pool cleaning robot to clean each area at the bottom of the pool independently, it must walk according to certain line route rules. Therefore, it is necessary to measure the real-time position and posture of the robot, so that it can independently send reasonable motion instructions according to the current information. The inertial measurement method of the combination of acceleration sensor and gyroscope used in the swimming pool cleaning robot can obtain the speed and position information through the acceleration and rotation angle of the robot. So that the robot itself can issue correct motion control commands according to the route walking rules set by the system and the current measurement information, so as to adjust the direction and speed of the next movement, and finally ensure that the motion route of the robot is consistent with the preset route. This robot needs to plan its route, which is troublesome to operate, and professional personnel are required for operation. In addition, in the pool with poor implementation range, the robot can easily collide with the pool wall and cause damage, and there is some dirt at the bottom of the swimming pool with strong adhesion, which cannot be cleaned by ordinary robots.

Therefore, we propose a swimming pool cleaning robot and steering method to solve the above problems.

### BRIEF DESCRIPTION OF DRAWINGS

Implementations of the present disclosure will now be described, by way of embodiment, with reference to the attached figures.

FIG. 1 is a system diagram of a swimming pool cleaning robot steering method proposed by the present disclosure.

FIG. 2 is a schematic diagram of the swimming pool cleaning robot inclined to the right according to the present disclosure.

FIG. 3 is a schematic diagram of the swimming pool cleaning robot inclined to the left according to the present disclosure.

FIG. 4 is a schematic diagram of the swimming pool cleaning robot travels vertically according to the present disclosure.

FIG. 5 is an overall axial side view of the swimming pool cleaning robot according to the present disclosure.

FIG. 6 is an overall structure diagram of an anti-collision guide assembly in the swimming pool cleaning robot proposed by the present disclosure.

FIG. 7 is an overall top view structure diagram of a swimming pool cleaning robot proposed by the present disclosure.

FIG. 8 is an overall structure diagram of a scraping assembly in a swimming pool cleaning robot proposed by the present disclosure.

FIG. 9 is an enlarged structure diagram of part A in FIG. 8.

### DETAILED DESCRIPTION

The technical scheme in the embodiment of the present disclosure will be clearly and completely described below in combination with the accompanying drawings in the embodiment of the present disclosure. Obviously, the described embodiments are only part of the embodiments of the present disclosure, not all of the embodiments of the present disclosure. Based on the embodiments of the present disclosure, all other embodiments obtained by those skilled in the art without creative efforts belong to the scope of protection of the present invention.

### First Embodiment

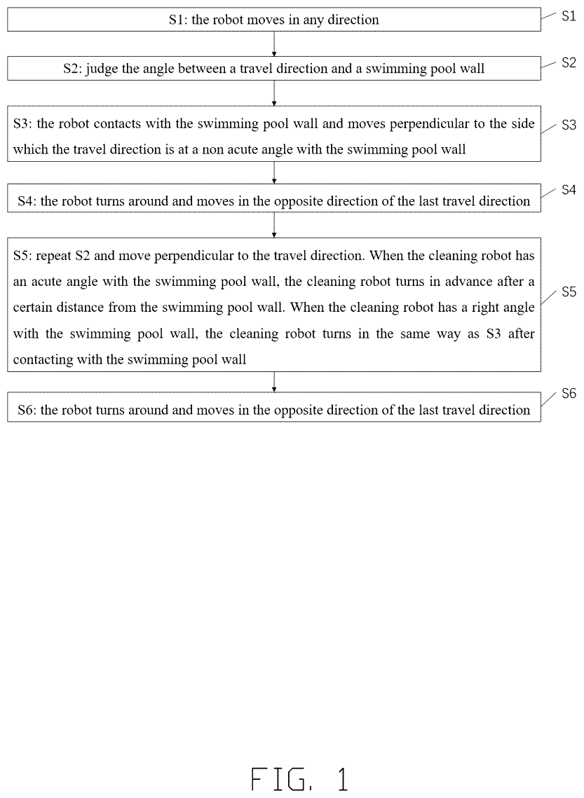

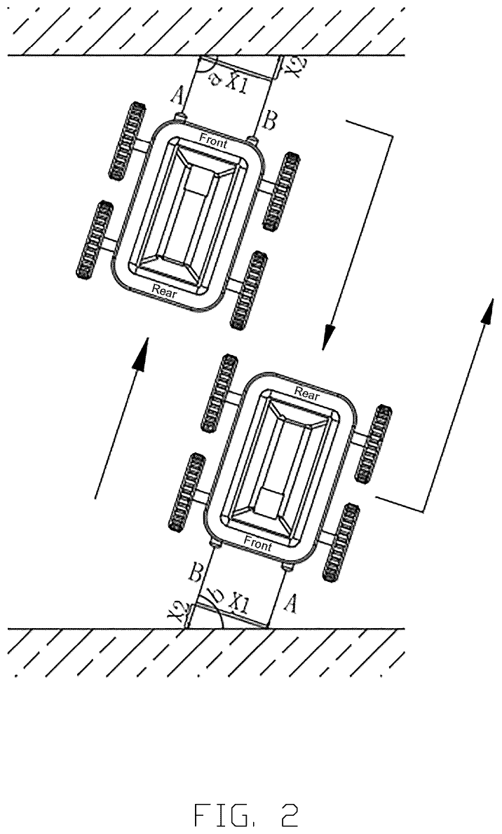

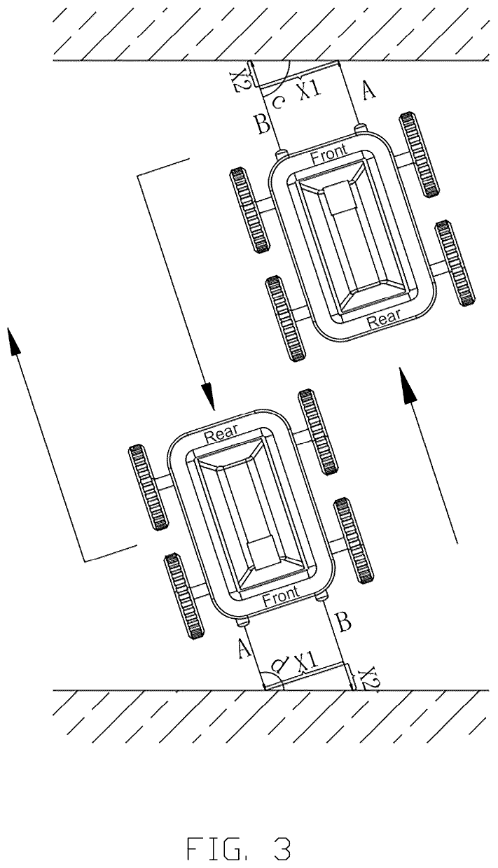

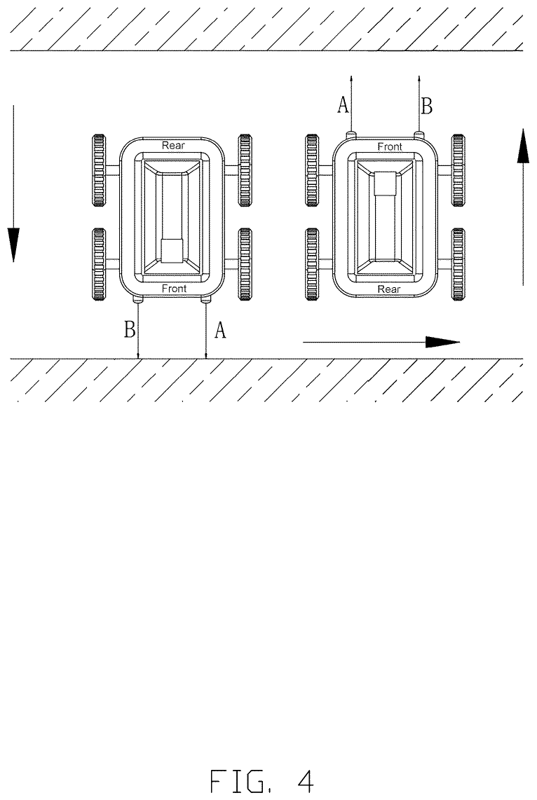

Referring to FIG. 1-4, this embodiment proposes a steering method of a swimming pool cleaning robot, the swimming pool cleaning robot including a cleaning robot body 1, an angle sensor, a gyroscope sensor and an acceleration sensor, and the angle sensor, the gyroscope sensor and the acceleration sensor are arranged inside the cleaning robot body 1, wherein the swimming pool cleaning robot further comprises a first sonar and a second sonar, and the first sonar and the second sonar fixed on a forward side of the cleaning robot body 1, the steering method comprising the following steps:
S1, the cleaning robot body 1 moves in any direction in the swimming pool;
S2, judge the angle between a travel direction and a swimming pool wall;
S3, the cleaning robot body 1 contacts with the swimming pool wall and moves perpendicular to the side which the travel direction is at an obtuse angle with the swimming pool wall;
S4, the cleaning robot body 1 turns around and moves in the opposite direction of the last travel direction;
S5, repeat S2 and moves perpendicular to the travel direction, when the cleaning robot body is at an acute angle with the swimming pool wall, the cleaning robot body 1 turns in advance after a certain distance from the swimming pool wall, when the cleaning robot body 1 is at a right angle with the swimming pool wall, the cleaning robot body turns in the same way as S3 after contacting with the swimming pool wall;
S6, the cleaning robot body 1 turns around and moves in the opposite direction of the last travel direction.

The specific steps of S2-S3 are as follows:

The distance between the first sonar 4 and the second sonar 5 is X1. When the cleaning robot body 1 enters the water for the first time, the first sonar 4 and the second sonar 5 send out ultrasonic wave, and the ultrasonic wave rebounds after touching the swimming pool wall. Therefore, it can be detected that the distance between the first sonar 4, the second sonar 5 and the swimming pool wall is A and B, and the distance difference between B and A is X2. The rotation angle of the cleaning robot body 1 can be determined by the angle sensor, and the orientation of the cleaning robot body 1 can be determined by the gyroscope sensor.

When B is longer than A, by calculating ∠a, ∠a=tan a+90°, tan a=X2/X1 between A and the swimming pool wall, the robot moves a certain distance in the direction perpendicular to B after touching the swimming pool wall, and then move in the opposite direction. The certain distance is less than or equal to the cleaning range of the cleaning robot body. There is local intersection between the two travel routes of the cleaning robot body 1.

The specific steps of S5-S6 are as follows: After the cleaning robot body 1 turns around once, calculate the ∠b, tan b=X1/X2 between B and A. After traveling for a certain distance, when the distance between the cleaning robot body 1 and the swimming pool wall is 1.2-1.5 times of the body radius of the cleaning robot body 1, the cleaning robot body 1 directly moves a certain distance in the direction perpendicular to A, then move in the opposite direction, and there is a local intersection between the two travel routes of the cleaning robot body 1. The certain distance is less than or equal to the cleaning range of the cleaning robot body. So far, the cleaning robot body 1 completes a travel of cleaning, and repeats the operation of the above travel to clean the whole bottom of the swimming pool.

### Second Embodiment

The difference from first embodiment is that the falling direction is opposite, that is, the distance between the first sonar 4, the second sonar 5 and the swimming pool wall is B<A. The ∠c between B and the swimming pool wall is calculated by calculating ∠a in S2. When ∠c >90°, the robot moves a certain distance after touching the swimming pool wall in the process of moving forward, then the robot moves in the opposite direction, and there is a local intersection between the two travel routes of the cleaning robot body 1. The certain distance is less than or equal to the cleaning range of the cleaning robot body.

After the cleaning robot body 1 turns around once, calculate the ∠d between the swimming pool wall and A by calculating ∠b in S3. When ∠d<90°, after the cleaning robot body 1 travels a certain distance, when the distance between the cleaning robot body 1 and the swimming pool wall is 1.2-1.5 times the body radius of the cleaning robot body 1, the cleaning robot body 1 moves a certain distance directly in the direction perpendicular to A, and then moves in the opposite direction. The certain distance is less than or equal to the cleaning range of the cleaning robot body. There is a local intersection between the two travel routes of the cleaning robot body 1. So far, the cleaning robot body 1 completes one travel, repeats the operation of the above travel to clean the whole bottom of the swimming pool.

### Third Embodiment

The difference from the first embodiment and the second embodiment is that the falling direction is perpendicular to the swimming pool wall. The specific steps are as follows:
S1, the cleaning robot body 1 moves along any direction in the swimming pool;
S2, judge the angle between the travel direction and the swimming pool wall;
S3, the cleaning robot body 1 contacts with the swimming pool wall and moves perpendicular to the side which the travel direction is at right angles to the swimming pool wall;
S4, the cleaning robot body 1 turns around and moves in the opposite direction of the last travel direction;
S5, repeat S2 and move perpendicular to the travel direction, after the cleaning robot body 1 contacts with the swimming pool wall, turns in the same way as S3;
S6, the cleaning robot body 1 turns around and moves in the opposite direction of the last travel direction, that is, the distance between the first sonar 4, the second sonar 5 and the swimming pool wall is A=B, and the cleaning robot body 1 moves back and forth in the direction perpendicular to the swimming pool wall.

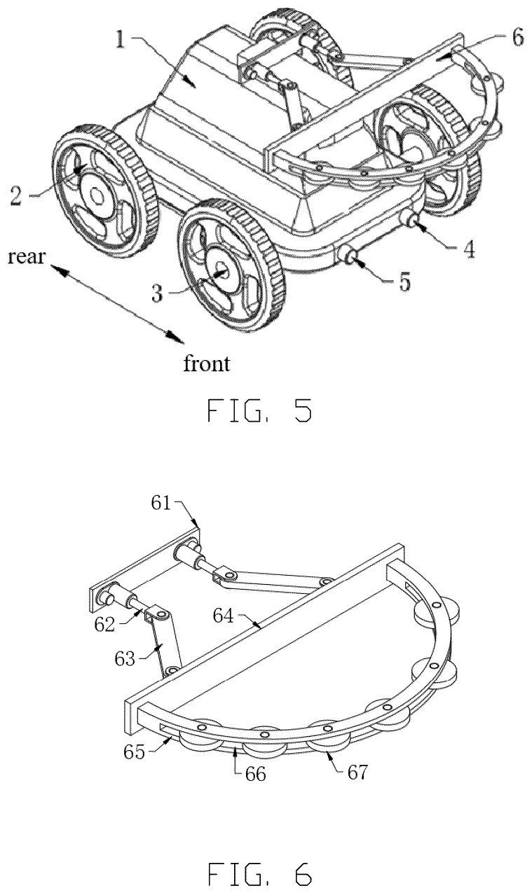

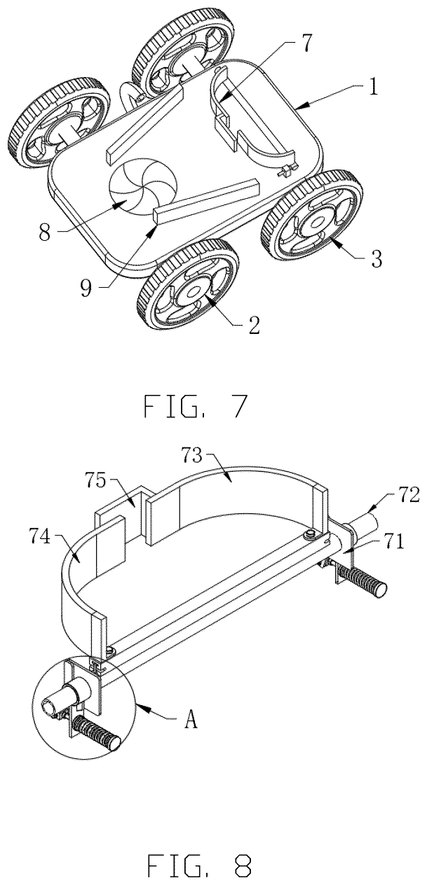

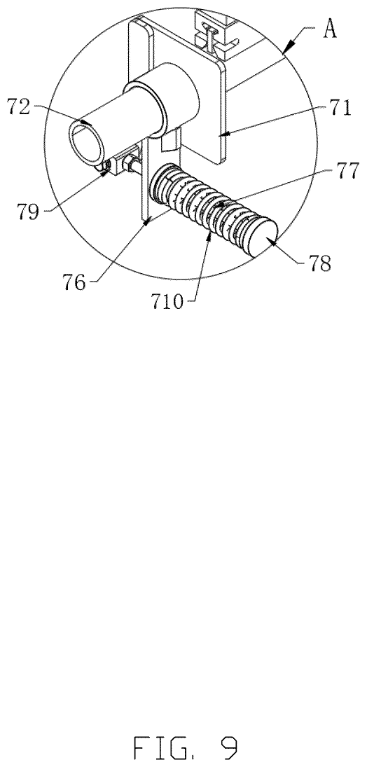

Referring to FIGS. 5-9, a swimming pool cleaning robot comprises a driving wheel 2 and a steering wheel 3 rotatably installed at the bottom of the cleaning robot body 1. The top of the cleaning robot body 1 is fixedly installed with an anti-collision guide assembly 6 for protecting the cleaning robot body 1, and the bottom of the cleaning robot body 1 is provided with a sewage suction port 8 and a scraping assembly 7 for cleaning and scraping the swimming pool.

Specifically, the first sonar 4 and the second sonar 5 can accurately measure the distance and angle between the cleaning robot body 1 and the inner wall of the swimming pool, so as to control the travel route of the cleaning robot body 1. When the cleaning robot body 1 is about to contact with the inner wall of the swimming pool, the anti-collision guide assembly 6 first contacts with the inner wall, it can avoid damage caused by the cleaning robot body 1 hitting the swimming pool wall, and can protect the cleaning robot body 1 during travel. During the travel of the cleaning robot body 1, the scraping assembly 7 can scrape up the dirt at the bottom of the swimming pool, and then facilitate the suction of the sewage suction port 8. It has a strong cleaning effect for some dirt stuck at the bottom of the swimming pool that is difficult to suck up.

Two inclined deflectors 9 are fixedly installed at the bottom of the cleaning robot body 1, and the scraping assembly 7 and the sewage suction port 8 are located between the two deflectors 9.

Specifically, the two inclined deflectors 9 can completely gather the dirt scraped by the scraping assembly 7, so that the dirt can be completely absorbed by the scraping assembly 7, and the cleaning effect of the cleaning robot body 1 is improved.

The anti-collision guide assembly 6 includes a mounting plate 61 fixedly connected with the top of the cleaning robot body 1. The front side of the mounting plate 61 is fixedly installed with two rebound damping rods 62, the two rebound damping rods 62 are hinged with an articulated rod 63, the two articulated rods 63 are hinged with the same rectangular plate 64, and the front side of the rectangular plate 64 is fixedly installed with an arc plate 65.

Specifically, when the anti-collision guide assembly 6 protects the cleaning robot body 1, the arc plate 65 first contacts with the swimming pool wall, and the diameter of the arc plate 65 is greater than the spacing between the two steering wheels 3, so as to ensure that the arc plate 65 first contacts with the swimming pool wall regardless of the angle at which the cleaning robot body 1 advances, so it can play a strong protective effect. When the arc plate 65 encounters an impact, the rectangular plate 64 tilts and drive the two rebound damping rods 62 to shrink and stretch to varying degrees through the two hinged rods 63, which can buffer the impact force on the arc plate 65 and the rebound damping effect of the rebound damping rod 62 is improved. It can avoid the violent rebound of the cleaning robot body 1 caused by the violent reset of the arc plate 65 when hitting the deflection arc plate 65, so that the travel route of the cleaning robot body 1 is not affected.

The scraping assembly 7 includes two fixing plates 71 fixedly connected with the bottom of the cleaning robot body 1. The two fixing plates 71 are rotatably installed with the same rotating shaft 72, and the rotating shaft 72 is fixedly installed with a first scraper 73 and a second scraper 74.

Specifically, two scraper 73, 74 can completely scrape up the dirt at the bottom of the swimming pool, which is convenient for the sewage suction port 8 to completely suck up the dirt.

The arc plate 65 is provided with an arc hole 66, in which a plurality of guide wheels 67 distributed at equal intervals are rotationally installed, the guide wheels 67 pass through the arc hole 66, and the rectangular plate 64 and the two articulated rods 63 are distributed in an isosceles trapezoid.

Specifically, multiple guide wheels 67 can avoid direct friction between the arc plate 65 and the swimming pool wall, and can also guide the progress of the cleaning robot body 1 when protecting the arc plate 65. There is stability between the isosceles trapezoidal distribution rectangular plate 64 and the two articulated rods 63, which can ensure that the anti-collision guide assembly 6 is always perpendicular to the cleaning robot body 1 during travel.

The rotating shaft 72 penetrates the fixing plate 71 and is rotationally connected with the fixing plate 71. Two vertical plates 76 are fixedly installed on the rotating shaft 72. The vertical plate 76 is provided with a guide rod 77. The guide rod 77 penetrates the vertical plate 76 and is slidably connected with the vertical plate 76. Both ends of the guide rod 77 are fixedly installed with a disc 78 and a fixing block 79. The fixing block 79 and the fixing plate 71 are fixedly connected together. The same spring 710 is fixedly installed on the side close to each other of the disc 78 and the vertical plate 76, and the spring 710 is sliding sleeved on the guide rod 77.

Specifically, when the second scraper 74 and the first scraper 73 encounter the bulge at the bottom of the swimming pool, they deflect with the rotating shaft 72 as the center and away from the bottom of the swimming pool. At this time, the fixing block 79, the guide rod 77 and the disc 78 drive the spring 710 to be compressed. When the first scraper 73 and the second scraper 74 cross the bulge, under the return elastic force of the two springs 710, the rotating shaft 72 drive the bottom of the first scraper 73 and the second scraper 74 to always contact with the bottom of the swimming pool, so it can continuously clean the bottom of the swimming pool.

The vertical plate 76 is provided with a rectangular hole, and the guide rod 77 passes through the rectangular hole and is slidably connected with the rectangular hole.

Specifically, the rectangular hole can ensure that the guide rod 77 can move up and down with a certain displacement when sliding in the vertical plate 76.

A third scraper 75 is fixedly installed on one side of the first scraper 73 close to the sewage suction port 8, and the length of the third scraper 75 is greater than the spacing between the first scraper 73 and the second scraper 74.

Specifically, the dirt that can pass through the spacing between the second scraper 74 and the first scraper 73 can be absorbed by the sewage suction port 8. The dirt that cannot pass through this spacing will always stay in the first scraper 73 and the second scraper 74, and the third scraper 75 can completely scrape away the dirt that cannot be scraped between the second scraper 74 and the first scraper 73.

Compared with the prior art, the beneficial effects of the present disclosure are as follows:

1. Through the first sonar and the second sonar, the present disclosure can drive the cleaning robot body to clean in the swimming pool where the surrounding environment cannot be viewed at all. The cleaning robot body moves regularly in the swimming pool, which can clean the bottom of the swimming pool well, solve the problem of inefficiency when random cleaning of the traditional cleaning robot, and there is no need to plan the cleaning route, it can be used directly in the swimming pool.

2. When the cleaning robot body is about to contact with the inner wall of the swimming pool, the anti-collision guide assembly first contacts with the inner wall, which can avoid damage caused by the cleaning robot body hitting the swimming pool wall, and can protect the cleaning robot body during travel.

3. During the movement of the cleaning robot body, the scraping assembly can scrape up the dirt at the bottom of the swimming pool, and then facilitate the suction of the sewage suction port. It has a strong cleaning effect for some dirt stuck at the bottom of the swimming pool that is difficult to suck up.

The above is only the preferred specific embodiment of the present disclosure, but the protection scope of the present disclosure is not limited to this. Any technician familiar with the technical field who makes equivalent replacement or modification according to the technical scheme and inventive concept of the present disclosure within the technical scope disclosed by the present disclosure shall be covered by the protection scope of the present disclosure.

What is claimed is:

1. A swimming pool cleaning robot, wherein the swimming pool cleaning robot comprising:
two driving wheel and two steering wheel rotationally mounted at the bottom of a cleaning robot body, an anti-collision guide assembly fixedly installed on a top of the cleaning robot body, the anti-collision guide assembly being configured for protecting the cleaning robot body, a sewage suction port and a scraping assembly provided at a bottom of the cleaning robot body, the scraping assembly being configured to clean and scrap the swimming pool.

2. The swimming pool cleaning robot according to claim 1, wherein
the bottom of the cleaning robot body is fixedly mounted with two spoilers, and the two spoilers are obliquely arranged, and the scraper assembly and the suction port are located between the two spoilers.

3. The swimming pool cleaning robot according to claim 1, wherein
the anti-collision guide assembly comprises a mounting plate, the mounting plate is fixedly connected with the top of the cleaning robot body, a first front side of the mounting plate is fixedly installed with two rebound damping rods, and the two rebound damping rods are hinged with hinged rods, the two hinged rods are hinged with a same rectangular plate, and a second front side of the rectangular plate is fixedly installed with an arc plate.

4. The swimming pool cleaning robot according to claim 3, wherein
the arc plate is configured to contact with walls of a swimming pool, and a diameter of the arc plate is greater than a spacing between the two steering wheels.

5. The swimming pool cleaning robot according to claim 3, wherein
when the arc plate encounters an impact force, the rectangular plate tilts, and the two rebound damping rods are driven to shrink and/or stretch to different degrees by the two hinged rods, so as to buffer the impact force on the arc plate.

6. The swimming pool cleaning robot according to claim 1, wherein
the scraper assembly comprises two fixing plates, the two fixing plates are fixedly connected to the bottom of the cleaning robot body, the two fixing plates are rotatably mounted with a rotating shaft, and the rotating shaft is fixedly mounted with a first scraper board and a second scraper board.

7. The swimming pool cleaning robot according to claim 3, wherein an arc hole is provided on the arc plate, a plurality of guide wheels is rotationally installed in the arc hole and distributed at equal intervals, the guide wheels extend through the arc hole, and the rectangular plate and two articulated rods are distributed in an isosceles trapezoid shape.

8. The swimming pool cleaning robot according to claim 6, wherein
the rotating shaft penetrates through the fixing plate and is rotationally connected to the fixing plate, two vertical plates are fixedly installed on the rotating shaft, a guide rod is arranged on the vertical plate, and the guide rod penetrates the vertical plate and is slidably connected to the vertical plate, two ends of the guide rod are fixedly installed with a disc and a fixed block, the fixed block and the fixing plate are fixedly connected, one side of the disc and the vertical plate close to each other is fixedly installed with a spring, and the spring is slidably sleeved on the guide rod.

9. The swimming pool cleaning robot according to claim 8, wherein
a rectangular hole is provided on the vertical plate, and the guide rod extends through the rectangular hole and is slidably connected to the rectangular hole.

10. The swimming pool cleaning robot according to claim 6, wherein:
a third scraper is fixedly installed on a side of the first scraper close to the sewage suction port, and a length of the third scraper is greater than a spacing between the first scraper and the second scraper.
